(19) United States
(12) Patent Application Publication
(10) Pub. No.: US 2016/0216108 A1
(43) Pub. Date: Jul. 28, 2016

(54) Device for controlling the distribution of fluid ejected from a fluid nebulizing dispenser

(71) Applicant: INMAN S.r.l., Milano (IT)

(72) Inventor: Vincenzo BETTINELLI, Milano (IT)

(21) Appl. No.: 15/001,913

(22) Filed: Jan. 20, 2016

(30) Foreign Application Priority Data
Jan. 26, 2015 (EP) 15152564.9

(51) Int. Cl. G01B 21/20; B05B 1/02; B05B 12/00; G01J 5/00

(52) U.S. Cl. CPC G01B 21/20; G01J 5/0037; B05B 1/02; B05B 12/004; G01J 2005/0077

(57) ABSTRACT

Disclosed is a device for checking the distribution of fluid ejected from a nebulizing dispenser of fluid, of the type including a discharging nozzle for a nebulized fluid. The device having detecting means for detecting the temperature difference between at least part of the nebulized fluid ejected from the dispenser and a one contrast space, and/or the temperature difference caused by the nebulized fluid ejected from the dispenser to the contrast space. In this case, the contrast space is arranged so as to be at least partially incident to said nebulized fluid.

### CROSS-REFERENCE TO RELATED APPLICATIONS

This Application claims the benefit of European Patent Application No. EP15152564.9 filed Jan. 26, 2015, the contents of which are incorporated herein by reference.

### FIELD OF THE INVENTION

The present invention relates to the check of fluid nebulizing dispensers (or actuators) mainly dedicated to pharmaceutical, medical or cosmetic sectors.

### BACKGROUND OF THE INVENTION

The dispensing quality of a pharmaceutical or cosmetic product dispensed from these devices is a key requirement of the market.

Not only do the proper nebulization and the correct amount of dispensed product determine this quality, but also the dispensing shape/dimension/direction of this product that should preferably take the shape of a cone downstream of the dispenser.

The known art provides a manual sampled check of some dispensing devices by inserting a colored liquid for simulating the product inside the dispenser and dispensing such liquid against a detecting absorbent surface.

An operator examines and evaluates the spot of colored liquid in order to determine the quality of the dispenser under test.

Clearly, this is a time-consuming check which requires labor and causes the waste of the randomly chosen containers, thereby preventing them from being put on the market. Moreover, this kind of check does not allow to test all the manufactured dispensers.

### SUMMARY OF THE INVENTION

It is an object of the present invention to provide a system for recognizing the proper shape of the dispensing cone of a nebulizing, or spraying, dispenser, or the like. In particular, it is an object of the present invention to provide a system able to perform a non-invasive check thereby preventing the contamination of the dispenser itself, such that the latter can be put on the market.

Such objects are achieved by a system and a related operating method according to the appended claims.

In particular, according to an aspect of the present invention, a device for checking the distribution of fluid ejected from a fluid nebulizing dispenser, of the type comprising a discharging nozzle of nebulized fluid, comprises means for detecting the temperature difference between at least part of the nebulized fluid ejected from the dispenser and at least one contrast space, and/or the temperature difference caused to the contrast space by the nebulized fluid ejected from the dispenser. In this case, the contrast space is arranged so as to be at least partially incident to the nebulized fluid.

In other words, some fluid is nebulized from a discharging nozzle and placed in contact with a contrast space. Appropriate means detect the temperature difference between the fluid and the contrast space, thus identifying the fluid path downstream of the discharging nozzle.

According to an aspect of the present invention, the contrast space comprises a contact surface having a temperature different from said nebulized fluid ejected from said dispenser.

Therefore, the nebulized fluid can be dispensed against said contact surface such that the above mentioned detecting means can identify the mark left on the surface by the nebulized fluid. In particular, the detecting means identify such a mark because of its temperature which is different from the rest of the contact surface not touched by the nebulized fluid.

According to an aspect of the present invention, the contact surface is thermally connected to heating and/or cooling means.

Such heating/cooling means allow to lead the contact surface to a temperature different from the nebulized fluid.

According to another aspect of the invention, the contrast space comprises a volumetric portion of the environment downstream of the discharging nozzle.

In other words, the temperature difference between the fluid and the surrounding space allows the detecting means to identify the presence of the fluid nebulized by the dispenser downstream of the discharging nozzle.

According to an aspect of the present invention, the detecting means comprise at least one thermographic sensor to capture at least one image of the temperature difference between at least part of said nebulized fluid ejected from said dispenser and said contrast space and/or the projection of said image onto said contrast space.

The thermographic sensors, typically thermographic cameras, make the capture of an image of the nebulized fluid possible.

Further, or alternatively, the detecting means can comprise temperature sensors.

According to an aspect of the present invention, the contact surface is at least partially covered by a thermal-insulating material.

This allows to minimize the waiting times between the check of two different dispensers. This waiting time depends on the time taken to lead the contact surface to a uniform temperature in response to a check, that is the time taken to erase the mark of the fluid nebulized by a dispenser.

Preferably, such thermal-insulating material is film-like. According to a further aspect this thermal-insulating material is Teflon.

Another aspect of the present invention relates to a method for checking the distribution of the fluid ejected from a fluid nebulizing container according to one or more of the above aspects, comprising the steps of:
a) ejecting a nebulized fluid from said discharging nozzle;
b) detecting the temperature difference between at least part of the nebulized fluid and the contrast space and/or the temperature variation caused to the contrast space by the nebulized fluid.

### BRIEF DESCRIPTION OF THE DRAWINGS

Hereinafter, referring to the appended figures, exemplary and non-limiting embodiments of the present invention will be described, wherein:

FIG. 1 is a perspective view of an embodiment of the present invention;

FIG. 2 is a schematic view of a second embodiment of the present invention;

FIG. 3 is a perspective view of a modification of the embodiment of FIG. 2.

### DETAILED DESCRIPTION OF THE INVENTION

Referring to figures, a device 1 according to the present invention allows to check the distribution 2 of a fluid 3b ejected from a dispenser 4.

The dispenser 4 is known in the art and comprises a body 4a adapted to contain a fluid 3a, and a nozzle 4b adapted to nebulize and discharge such fluid 3b from the dispenser 4.

It can be clearly seen that the dispenser 4 shown in figures is only for illustration since the present invention is able to check differently-shaped dispensers and, in particular, a general dispenser provided with a discharging nozzle of a nebulized fluid.

Typically, during the normal use of the dispenser 4, the fluid 3a, 3b is selected from a cosmetic (e.g. a perfume) or a pharmaceutical or medical fluid. Hereinafter, for the sake of convenience, the same fluid 3a, 3b is referred to by means of two different reference numerals. In particular, when the fluid is contained inside the dispenser 4 (or in any case before being dispensed from the nozzle 4b), it is indicated as fluid 3a whereas, once it has been ejected from the dispenser 4 through the nozzle 4b, it is indicated as fluid 3b.

According to an aspect of the present invention, to carry out the quality control of the dispenser 4, the fluid 3a, 3b preferably is an inert gas (for example suitably filtered air). Since the inert gas does not contaminate the dispensers 4, the same dispensers 4 undergoing a check may subsequently be put on the market.

The fluid 3b can be dispensed from the discharging nozzle 4b according to different methods. For example, according to an embodiment, the single discharging nozzle 4b, fluidically connected to a fluid source 3a, is tested. Adjusting means 6b can be provided in order to adjust the dispensing pressure of the fluid 3b.

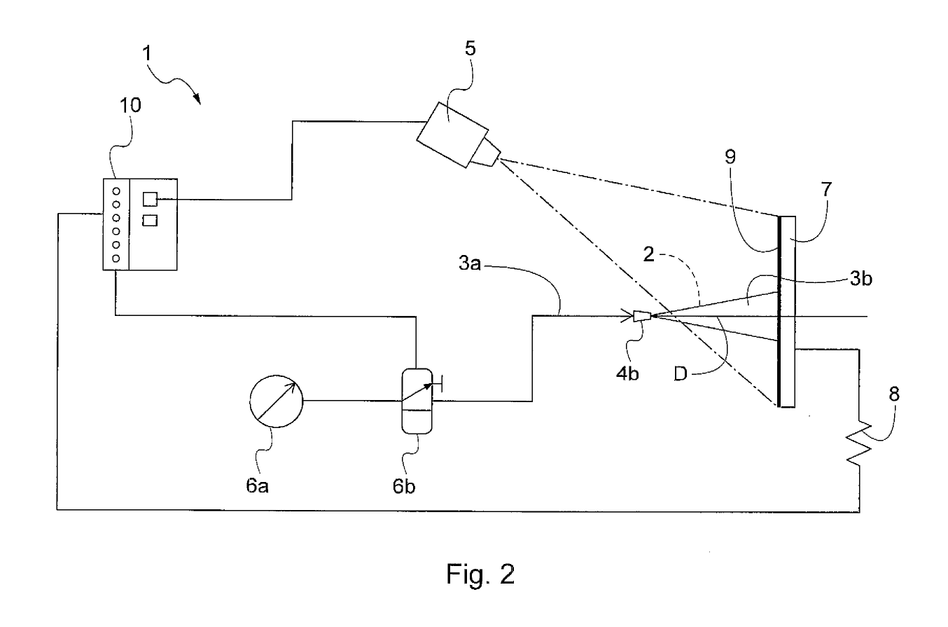

In particular, a compressor 6a and a valve 6b respectively acting as a fluid source 3a and adjusting means, are shown in FIG. 2. Alternatively, the compressor 6a can be adjustable so as to change the dispensing pressure in order to act as both source and adjusting means, simultaneously.

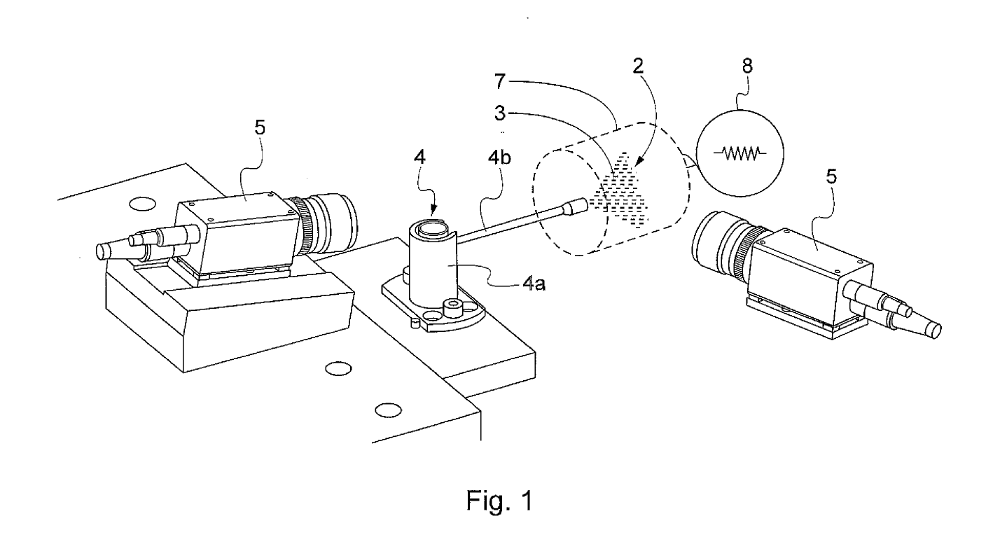

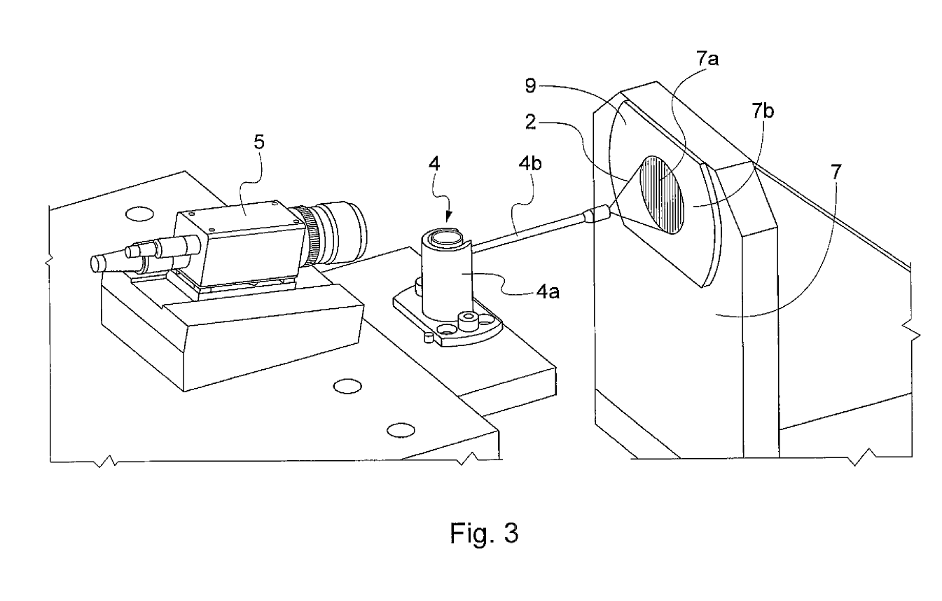

In the embodiments shown in FIGS. 1 and 3, the discharging nozzle is mounted instead on the body 4a of the dispenser 4. The dispensing of nebulized fluid 3b is controlled by operators, or suitable automated actuators, not shown, by acting on the body 4a. Alternatively, in place of the dispenser body 4a, the nozzle 4b can be mounted on a specific element adapted to contain the fluid and to couple with the nozzle itself. The device 1 according to the present invention further comprises detecting means 5 for detecting the temperature difference between at least part of the nebulized fluid 3b ejected from the dispenser 4 and at least one contrast space 7, and/or the temperature difference which is caused by the nebulized fluid 3b ejected from the dispenser 4 to the contrast space 7.

In other words in a first embodiment shown in FIG. 1, the means 5 detect the temperature difference between a nebulized fluid 3b and a surrounding space, whereas in a second embodiment shown in FIGS. 2 and 3, the means 5 detect the temperature difference between two portions 7a, 7b of a contrast space 7, that is a first portion 7a that came in contact with the nebulized fluid 3b (i.e. the mark 7a left on the contact surface 7 by the fluid 3b), and a second portion 7b that was not contacted by this fluid 3b.

In a possible embodiment shown in FIG. 1, the means 5 detect the temperature of the environment downstream of the discharging nozzle 4b after the fluid 3b has been dispensed.

Apposite heating/cooling means 8 (schematically shown in FIG. 1) operate on the contrast space 7 by cooling or heating it with respect to the fluid 3a. According to a modification not shown, the heating and/or cooling means 8 lead the fluid 3a to a different temperature with respect to the contrast space 7. For example, heating means 8 can heat the fluid 3a before it is discharged from the dispenser 4.

After dispensing the fluid 3b, the means 5 are able to detect the areas downstream of the dispenser 4 in which the nebulized fluid 3b is present. In particular, the means 5 are able to detect areas of the contrast space 7 at a higher temperature, which identify the distribution 2 of the nebulized fluid 3b, whereas the areas at a lower temperature identify the contrast space 7 in which the same fluid 3b did not flow.

Preferably, the means 5 comprise at least one thermographic camera, e.g. two cameras, in order to obtain information about the three-dimensional distribution of the fluid 3b. Typically, the required thermographic cameras must be able to obtain high-resolution images and accurately capture a moment immediately after dispensing the fluid 3b.

Alternatively, the means 5 comprise a plurality of temperature sensors (not shown) conveniently positioned downstream of the dispenser 4.

In a second embodiment, the distribution 2 of the fluid 3b is indirectly detected.

In particular, referring to the embodiments of FIGS. 2 and 3, the contrast space 7 comprises a contact surface 7. Special means 8 heat the surface 7 up to a temperature different from the temperature of the fluid 3a, 3b. Alternatively, means can be provided which lead the temperature of the surface 7 so as to be lower than the temperature of the fluid 3a, 3b.

According to further variations, the means 8 operate on the fluid 3a, 3b by cooling or heating it with respect to the contact surface 7.

Preferably, the contact surface 7 is covered by a film 9 made of a thermal-insulating material, for example Teflon. As better explain hereinafter, the film 9 allows to minimize the time between two subsequent checks of two different dispensers 4.

The surface 7 is arranged so as to be incident to the fluid 3b ejected from the dispenser 4. Preferably, the contact surface 7 is arranged so as to be substantially perpendicular to the main emission direction D of the nozzle 4b.

Detecting means 5 allow to detect the mark 7a left by the fluid 3b on the contact surface 7 (or on the film 9, if present).

Similarly to the previous embodiment, these means 5 preferably comprise at least one thermographic camera. Since in this embodiment a two-dimensional image has to be detected, i.e. the mark 7a of the fluid 3b on the contact surface 7 (or the film 9), it is therefore possible to use a single thermographic camera.

Alternatively, a plurality of temperature sensors, suitably distributed on the contact surface 7, can be used.

Once the shape of the mark 7a left by the fluid 3b ejected from the container 4 on the contact surface 7 (or the film 9) has been detected, it is then possible to process the distribution 2 of the fluid 3b exiting from the dispenser 4 by means of known mathematical functions.

Typically, such processing operations are performed by a computer 10.

In order perform this processing, it is also preferable to set, in a known manner, at least the distance between the dispenser 4 and the contact surface 7 (or film 9).

In use, a fluid 3b is discharged from the dispenser 4.

As mentioned, this operation can be controlled so that the dispensing pressure of the fluid 3b can be adjusted, for example by means of a compressor 6a and optionally a valve 6b. Alternatively, for example in the embodiments shown in FIGS. 1 and 3, it is possible to control the operating speed of the actuators controlling the dispensing of the fluid 3a, 3b from the dispenser 6.

The temperature of the fluid 3b is set so as to be different with respect to that of the contrast space 7. As anticipated, this operation can be performed by heating or cooling the fluid 3a, 3b, and/or heating/cooling the contrast space 7.

Subsequently, the distribution of the fluid 3b can be verified by the means 5.

In the previously described first embodiment, the means 5 directly identify (e.g. by a thermographic picture) the distribution of fluid 3b, i.e. the “cone” formed by the fluid 3b downstream of the dispenser 4.

In the second embodiment, the means 5 indirectly identify the distribution of fluid 3b, in particular by detecting a section or mark 7b (stamped on the surface 7 or on the film 9) of the “cone” formed by the fluid 3b downstream of the dispenser 4. Preferably, the means 5 are able to identify the shape of the mark 7a, the size of the mark 7a, the position of the center of the mark 7a.

Having these three data and preferably knowing the position of the discharging nozzle 4b as well, it is possible to define the proper geometry of the distribution 2 of the nebulized fluid 3b and check if the shape, size and direction of the distribution 2 are correct.

As previously mentioned, preferably the surface 7 may be covered by a thermal-insulating film 9, for example made of Teflon. When the fluid 3b collides with the film 9, the latter is very quickly cooled by the fluid itself, but only on the surface. After the detection has been performed by the means 5, the surface 7 heated by the heating means 8 can lead the film 9 back to the initial temperature, so as to allow to quickly perform a subsequent check of another dispenser 4.

Generally, in order to detect the distribution 2 of the fluid 3b, the means 5 are preferably actuated before and after dispensing the fluid 3b. The effect of the fluid 3b on the contrast space 7 can be better highlighted by the difference between the two detections of the means 5. For example, one (or more) thermographic camera is operated to take two pictures: a first picture before dispensing the fluid 3b, and a second picture a preset time after dispensing. The difference between the two pictures highlights the influence of the fluid 3b with respect to the contrast space 7 thereby allowing to obtain information about the distribution 2 of the fluid 3b.

As previously mentioned, preferably a computer 10 processes the data obtained by the means 5 in order to analytically reproduce the shape of the distribution 2 of the fluid 3b.

In particular, by performing the virtual reproduction, typically by means of a computer 10, it will be possible to verify, among other things: the shape, size and space orientation of the distribution 2 of the nebulized fluid 3b ejected from the nozzle 4b of the dispenser 4.

Depending on the result, the just checked dispenser 4 is put on the market or rejected.

1. Device for checking the distribution of fluid ejected from a nebulizing dispenser of fluid, having a discharging nozzle for a nebulized fluid, said device having detecting means for detecting the temperature difference between at least part of said nebulized fluid ejected from said dispenser and at least one contrast space and/or the temperature difference caused by said nebulized fluid ejected from said dispenser to said contrast space, said contrast space being arranged so as to be at least partially incident to said nebulized fluid.

2. Device according to claim 1, wherein said contrast space comprises a contact surface having a temperature different from said nebulized fluid ejected from said dispenser.

3. Device according to claim 2, wherein said contact surface is thermally connected to heating and/or cooling means.

4. Device according to claim 1, wherein said contrast space comprises a volumetric portion of the environment downstream of said discharging nozzle.

5. Device according to claim 1, wherein said detecting means comprise at least one thermographic sensor to capture at least one image of the temperature difference between at least part of said nebulized fluid ejected from said dispenser and said contrast space and/or the projection of said image onto said contrast space.

6. Device according to claim 1, wherein said detecting means comprise temperature sensors.

7. Device according to claim 2, wherein said contact surface is at least partially covered by a thermal-insulating material.

8. Device according to claim 7, wherein said surface is at least partially covered by a film of thermal-insulating material.

9. Device according to claim 7, wherein said thermal-insulating material is Teflon.

10. Method for checking the distribution of fluid ejected from a fluid nebulizing dispenser by means of a device according to claim 1, comprising the steps of:
a) ejecting a nebulized fluid from said discharging nozzle; and
b) detecting the temperature difference between at least part of said nebulized fluid and said contrast space and/or the temperature variation caused by said nebulized fluid to said contrast space.

11. Method according to claim 10, wherein during said step, said detection is carried out on a contrast space comprising a contact surface having a temperature different from said nebulized fluid exiting from said dispenser.

12. Method according to claim 11, wherein said contact surface is thermally connected to heating and/or cooling means leading at least part of said contact surface to a temperature different from said nebulized fluid.

13. Method according to claim 10 wherein, in said detecting step, at least one thermographic sensor captures at least one image of the temperature difference between at least part of said fluid ejected from said dispenser and said contrast space.

14. Method according to claim 10 wherein, in said detecting step, at least one temperature sensor records the temperature difference between said fluid and said contrast space and/or the temperature variation said fluid ejected from said dispenser causes to said contrast space.

15. Method according to claim 10, wherein in said step a control is carried out over the dispensing pressure of said fluid.
